(19) United States
(12) Patent Application Publication
(10) Pub. No.: US 2015/0371548 A1
(43) Pub. Date: Dec. 24, 2015

(54) KNOWLEDGE AND NETWORK CURRENCY SYSTEMS AND PAYMENT PROCEDURES

(71) Applicant: Gideon Samid, Rockville, MD (US)

(72) Inventor: Gideon Samid, Rockville, MD (US)

(21) Appl. No.: 14/743,908

(22) Filed: Jun. 18, 2015

Related U.S. Application Data
(60) Provisional application No. 62/014,103, filed on Jun. 18, 2014.

(51) Int. Cl. G09B 7/08

(52) U.S. Cl. CPC G09B 7/08

(57) ABSTRACT

System and methods for various knowledge dissemination and grading over a network comprised of human and/or artificial intelligence entities; leveraged by pay-as-you-go for services provided at any resolution, and paid for real time with digital cash. Enhancing fairness and efficiency by replacing subscription models with per-use payment regimen.

### OVERVIEW

This document is comprised of three parts: Part 1: Leveraging Testing Methods and Grading Procedures, discusses the dissemination of recognition currency (e.g. grades) within a community of network nodes in a learning mode. This part offers procedures designed to upgrade the efficiency of knowledge dissemination (learning). The second part: Digital Currency Payment Regimen described ways by which high-resolution per-node money can be stored, and paid to upgrade performance efficiency, and the third part: Double Anonymous Knowledge Marketplace Architecture (DAKMA) lays out procedures to upgrade knowledge dissemination throughout the network.

Table of Contents

| | |
|---|---|
| LEVERAGING TESTING METHODS AND GRADING | 5 |
| PROCEDURES | |
| INTRODUCTION: | 5 |
| KNOWLEDGE UNCERTAINTY, AND CASES OF JUDGMENTS | 7 |
| Tightness | 8 |
| Grading Choice-Overlapping Questions: | 8 |
| Boosting Teaching Efficiency: | 10 |
| Analysis of the Proposed Testing and Grading Procedure | 14 |
| ANOTHER LOOK AT BOOSTING TEACHING EFFICIENCY | 15 |
| PROGRAMMING LEVEL SPECIFICATION | 18 |
| EXPLANATIONS OF THE DRAWINGS | 23 |
| DIGITAL CURRENCY PAYMENT REGIMEN EXERCISED ALSO | 25 |
| IN THE INTERNET-OF-THINGS | |
| PAYMENT-AI | 25 |
| THE IOT PAYMENT ENVIRONMENT | 26 |
| IOT PAYMENT PRINCIPLES | 27 |
| PROTOCOLS | 28 |
| SECURITY | 31 |
| AVATARS | 32 |
| DEAL-MAKING CONTROL | 35 |
| NODE HIERARCHY | 37 |
| MAN-MACHINE RELATIONSHIP | 38 |
| NETWORK MONEY | 39 |
| THE ECONOMY OF THINGS | 40 |
| PLATFORM NOTES | 40 |
| CURRENCY EXCHANGE | 40 |
| TRUST DESIGNATION | 41 |
| DISPUTE RESOLUTION | 42 |
| EMERGENCY MANAGEMENT | 42 |
| COUNT DOWN TO PAYMENT EXPLOSION | 42 |
| FAIR PAY V. FREE: WHY THE INSTINCTIVE CHOICE IS | 45 |
| WRONG | |
| ALGORITHMIC SHOPPING | 46 |
| MICROPAYMENT AND CYBERSECURITY - | 49 |
| THE “TOLL ROAD”SOLUTION | |
| PAYMENT PROTOCOLS | 51 |
| DOUBLE-ANONYMOUS KNOWLEDGE MARKETPLACE | 54 |
| ARCHITECTURE (DAKMA) | |
| INTRODUCTION | 55 |
| KNOWLEDGE EXCHANGE CURRENCY | 57 |
| ANONYMITY | 58 |
| KNOWLEDGE MIDDLEMAN | 58 |
| IMPLICATIONS & SCENARIOS | 59 |
| ILLUSTRATION: MEDICAL KNOWLEDGE | 59 |
| KNOWLEDGE EXCHANGE PROTOCOLS | 60 |
| VALIDATION PROTOCOLS | 65 |

[symbol]

### Leveraging Testing Methods and Grading Procedures

Abstract: We propose testing methods and grading procedures that are designed to (i) keep the lagging student in greater contact with the studied material, and (ii) serve as an effective feedback for the teacher to avoid under-teaching and over-teaching. These procedures apply equally to human students and to artificial intelligence entities on the same or different network. The proposed procedures are based on the tried old concept of multiple-choice questions where grading is algorithmically determined, sparing the grader from bias accusations. The test should be calibrated to result in an even distribution of grades from a base minimum up—in order to insure efficient teaching sessions; students should be asked to rerun low-grade tests, again and again until they achieve a threshold grade. These re-submissions are against reported grades, which do not identify the incorrect answers. Grading is based on how many re-trials were needed. Resubmitting the same multiple-choice test keeps the lagging student in contact with the studied material.

### Introduction

Testing and grading are fundamental undisputed means to boost learning and teaching efficiency. The respective procedures may be cast into two main categories:
constructive tests
selective tests

In the former, the student is asked to assemble some pieces, to be creative, to build an entity. In the latter, the student is asked to select one answer among several.

Another division applies to grading:
Objective grading
Subjective grading

Generally constructive tests require subjective grading (e.g.: grading an essay) while selective testing is conducive to objective grading. The efficacy of testing and grading is generally enhanced when the grading is objective.

In this work we regard selective tests only. In particular we regard a test comprised of q questions, each associated with n choices among which the tested student has to make his or her selection.

In the “base line case” only one of the n choices is correct, and the others are not. Grading is straight forward: c/q, where c is the number of correctly answered questions.

The challenge here is for the grader (the teacher) to be creative and develop good, relevant questions, such that correct answers to them is a faithful indication of mastery of the studied material. As opposed to a constructive test where a teacher can say: ‘summarize the last lesson’—and let the student be creative and resourceful.

The first question we discuss here is how to adjust the difficulty of the test questions. The obvious ways is to increase the number of questions (q), as well as the number of choices per question, (n). The choices can be expressed ‘tighter’ to confuse the student with only shallow knowledge. Also, most learned materials could be quizzed as to repetition of what was learned, and as to using the same to infer certain results. The latter is a greater challenge for understanding. In general, we assume that a set of selective questions can be made as hard, or as easy as desired.

### Knowledge Uncertainty, and Cases of Judgments

Normally a multiple-choice question is expected to have only one answer marked as correct, and the other (n−1) answers marked as errors. When there is one knowledge-source, (one teacher) then this is his or her (or its) responsibility to insure that no other answer apart from the correct one has any credible claim for being reasonably correct. Alas, in cases of uncertainty and judgment, we may find instances where experts and mavens disagree. In that case some formula for correctness will have to be worked out. For example a given questions is presented with n=4 answers: a, b, c, and d. If there is one teacher who marked, say answer c is the correct and the other as incorrect then the correctness histogram over a, b, c, and d respectively will be 0, 0, 100, 0. In the other extreme when a set of experts on the network disagrees so that the correctness histogram looks like: 25, 25, 25, 25, then any answer by the test-take is as good as any other. But in in-between cases, like: 0, 5, 65, 30 over a, b, c, and d, then a d answer might fetch 30% of the score from this question and answer c will fetch 65% thereto.

### Tightness

The competing n options may obviously be set out as “easy” and “loose”, for example: question: what is the root of 81? Answers: 1. a house on the prairie, 2. the letter Z, 3: the root is my grandmother, and 4. the root of 81 is 9. Even with a very vague notion of “root” the right answer can be readily picked out. It is less obvious, and more difficult to present ‘tight’ answers to the same question, for example: 1. the root of 81 is the same as the square of 3, 2. 81 has no root, 3. the root of 81 equals to the root of 100 minus the root of 3, and 4. there is no such a thing as a root of a number. In this case, obviously, it would not as easy for a clueless respondent to pick the right answer. Clearly a human teacher can come up with loose or tight answer options to test a class of students to find out how deep they understand the material. Tightness and looseness can also be achieved with AI where the percentage of like-minded students (or learning entities) who picked the right answer signifies ‘tightness’.

### Grading Choice-Overlapping Questions

The n choices in a multiple-choice case may be assigned a fuzzy correctness index c(i) for i=1, 2, . . . n such that Σ c(i)=100. In that case the student will receive P*(c(s)/c(max)) grade points where P is the maximum grade points for this question, c(max) is the option with the highest correctness index, and c(s) is the correctness index of the selected option, s (s=1, 2, . . . n).

Normally if the grader is a single source (a single person) then the choices may be selected such that all but one have a zero, or near zero correctness index. However, in soft sciences, correctness may be best decided by a panel of experts who may have some disagreement. In that case the choice selection by the experts may be mathematically translated to fuzzy correctness indices.

Obviously for the case where c(i)=1/n for all n options of a given question, the question is useless, and by contrast, the question is most useful in the opposite case where c(i)=0 for all but a certain i=j for j being the single correct option j=1, 2, . . . n. The in-between situations may be assigned a utility index between 0 and 1 by use of Shannon entropy function, H:

Uk=Hk/Hmax

where Uk is the utility of a question for a given distribution of correctness index, designated as situation k, and Hk and Hmax are the respective entropy of situation k and the maximum entropy (log(n)).

In the following sections we will outline the proposed methods for improved teaching, and those for improved study.

### Boosting Teaching Efficiency

Education and training are essential in modern life, yet for most of us the price of learning is very costly in terms of time-invested. This highlights teaching efficiency as a most crucial aspect. The dilemma: how not to under-teach (present material already known to the students), and how not to over-teach (leave the students behind in understanding the material). We developed a methodology for balanced teaching based on frequent multiple-choice quizzes. The grade distribution of the quizzes distinguishes between under-, over-, or balanced teaching, instead of showering the students with a flood of high grades, or low-grades. Efficient teaching happens when the grades curve has a “healthy” slope off the 100% mark. It indicates that some students absorbed the entire lesson, and fewer and fewer absorbed decreasingly less. By contrast, if all students scored 100% then it indicates under-teaching. It suggests that the teaching could have gone deeper, faster, more material could have been covered—greater teaching efficiency achieved. On the other hand, if most grades are ‘failed’ then we face an over-teaching state: the teacher has lost his or her students, teaching too fast, too deep, too far removed from the state of knowledge of the students.

These feedbacks are valid to the extent that the grades are computed off an objective quiz that was written to accurately reflect the lesson taught in practice (not the theoretical objective for this session).

A frequent application of such quizzes will indicate the extent of balance in class. It will guide the teacher to relax over-teaching, and to intensify under-teaching.

These quizzes will also flash out a poorly matched class. If for some of the students a particular teaching regimen is registered as over-teaching, and for another group of class students the same teaching regimen registers as under-teaching, then it is impossible to modify the teaching regimen in favor of the entire class. Intensifying the teaching will harm the over-taught, and relaxing the teaching will harm the under-taught. The proper solution in such a situation is to break up the students to two classes, such that for each class the matching of students will be effective.

For this method to succeed it is important to construct the quizzes to accurately reflect the lesson taught. One must be aware that in today's Internet search reality, students may write essays, analyses, and reports that present excellent quality, which nonetheless does not reflect the level of comprehension of the student. It's a new skill acquired by todays' students: how to glean material from the Internet, mix and match, and construct a report that conceals its Internet origin, but it reflects the comprehension of the original writer, not the comprehension of the “Internet lifter”. The students then acquire an undeserving grade, and the teacher is misled with non-accurate teaching-efficiency data.

An effective tool to counter this phenomenon of Internet-lifting is to construct the quiz as a series of multiple-choice questions. The choices to choose from must be ‘confusing’ to the shallow student; they must be close enough, and sound reasonable enough for a student who is not accustomed to profound comprehension. On the other hand, the choices must yield a clear single answer. If any two choices are so close that either one will qualify as correct then the quiz is unsatisfactory.

The quizzes must be tailored to the nature of the class: if its objective is to teach material as is (for memory retention) then the quizzes must be taken in class without access to resources, and represent the facts to be memorized. If the objective of the class is to enhance the judgment calls of the students, and their inferential capability, then the quizzes must present competing judgment calls to train their thought process.

When a teacher finds his or her quizzes out of balance, then the next lesson must compensate for the imbalance. Over-teaching must be responded to with easier, slower, more illustrated teaching, and under-teaching must be responded to with faster, tighter, more advanced teaching. Either case, the next quiz should show a result closer to the balance point. There are several possible dynamics: stable, unstable, and overly cautious options, in terms of the off-balance results of successive quizzes.

A teacher adhering to, and learning from the quiz-by-quiz feedback, will be able to exercise a series of teaching iterations that would sum up to improved teaching efficiency.

Improved Absorption of Studied Material: We consider a situation where a teacher composes q multiple-choice questions to test his or her students per a given lesson.

Each question is associated with n answers to choose from. The common procedure for this configuration is as follows:

Each student completes the test, and is graded as 100*(r/q), where r is the number of correct, (right), answers. After grading the correct answers are announced and the student, presumably examines his wrong answers and studies them until he or she understand why they were wrong, and what is the right answer.

Only that in reality students mind their grade, not their absorption of the material. Once the grade is set, there is little interest in the mistaken answers.

We propose then the following procedure:
1. Student submits the test, with his or her best answers.
2. The teacher responds with a grade (r/q), but does not identify which are the correct answers (except when r=q in which case all answers are correct).
3. If r=q the procedure ends. If r<q then the student revisits the test and resubmits.
4. Step 2 is repeated.

Let t represent the number of times the student submitted the same test. t will then be used to compute the final grade for this procedure. Grading can be computed in various ways: obviously G(t=1)=A, or 100%, where G(t=1) is the grade for t=1. Grades: G(t=2, 3, 4, . . . ) may be determined arbitrarily conforming to the principle that the higher value of t, the lower the grade. Grading can also be based on where t lies in the expanse between t_{best} case and t_{worst} case, where the former is assigned the grade A, and the latter the grade F, or any other desired grade.

The above procedure may be modified in several ways: Mod-1: repeating the re-submissions up to a cut-off grade that may be lower than 100%. Mod-2: limiting the number of rounds, tmax, and then grading based on t and the last result achieved. Mod-3: exacting a penalty for each round of resubmission, say 5%, and then, for example assigning the grade of 90% to a student that got all the answer right in the third submission.

### Analysis of the Proposed Testing and Grading Procedure

The proposed testing and grading procedure keeps the student engaged with all the questions of the test, until he or she spots the right answer to every single one of them. The more lagging the students, the more he or she are induced to spend time thinking of these questions, trying to spot their right answer. This re-engagement is a major advantage compared to being given the right answers after the quiz grade is announced.

This proposed method also ‘shakes up’ the non rigorous student who ‘bets’ on a given answer without being too sure about it. This is because when receiving the feedback that the grade of submission, k: rk/q<1, the student is not sure which are the right r answers. If he or she responded to question j by ‘gambling’ on an answer, without being sure, then after the grading the student will not be sure that he or she gambled wrong. This may lead to changing a correct answer to an incorrect one, and as a result scoring less in the latest submission, compared to the previous score. This is a bit annoying, and a bit galvanizing with a sense of ‘gambling’, but at any rate keeps the student in suspense as he or she resubmits and resubmits.

This method also offers grading flexibility, in terms of translating the number of submissions, t, to a quiz grade.

### Another Look at Boosting Teaching Efficiency

### Frequent Quizzes Lead to Improvement Iterations

Education and training are essential in modern life, yet for most of us the price of learning is very costly in terms of time-invested. This highlights teaching efficiency as a most crucial aspect. The dilemma: how not to under-teach (present material already known to the students), and how not to over-teach (leave the students behind in understanding the material). We developed a methodology for balanced teaching based on frequent multiple-choice quizzes. The grade distribution of the quizzes distinguishes between under-, over-, or balanced teaching, instead of showering the students with a flood of high grades, or low-grades. Efficient teaching happens when the grades curve has a “healthy” slope off the 100% mark. It indicates that some students absorbed the entire lesson, and fewer and fewer absorbed decreasingly less. By contrast, if all students scored 100% then it indicates under-teaching. It suggests that the teaching could have gone deeper, faster, more material could have been covered—greater teaching efficiency achieved. On the other hand, if most grades are ‘failed’ then we face an over-teaching state: the teacher has lost his or her students, teaching too fast, too deep, too far removed from the state of knowledge of the students.

These feedbacks are valid to the extent that the grades are computed off an objective quiz that was written to accurately reflect the lesson taught in practice (not the theoretical objective for this session).

A frequent application of such quizzes will indicate the extent of balance in class. It will guide the teacher to relax over-teaching, and to intensify under-teaching.

These quizzes will also flash out a poorly matched class. If for some of the students a particular teaching regimen is registered as over-teaching, and for another group of class students the same teaching regimen registers as under-teaching, then it is impossible to modify the teaching regimen in favor of the entire class. Intensifying the teaching will harm the over-taught, and relaxing the teaching will harm the under-taught. The proper solution in such a situation is to break up the students to two classes, such that for each class the matching of students will be effective.

For this method to succeed it is important to construct the quizzes to accurately reflect the lesson taught. One must be aware that in today's Internet search reality, students may write essays, analyses, and reports that present excellent quality, which nonetheless does not reflect the level of comprehension of the student. It's a new skill acquired by todays' students: how to glean material from the Internet, mix and match, and construct a report that conceals its Internet origin, but it reflects the comprehension of the original writer, not the comprehension of the Internet lifter. The students then acquire an undeserving grade, and the teacher is misled with non-accurate teaching-efficiency data.

An effective tool to counter this phenomenon of Internet-lifting is to construct the quiz as a series of multiple-choice questions. The choices to choose from must be ‘confusing’ to the shallow student; they must be close enough, and sound reasonable enough for a student who is not accustomed to profound comprehension. On the other hand, the choices must yield a clear single answer. If any two choices are so close that either one will qualify as correct then the quiz is unsatisfactory.

The quizzes must be tailored to the nature of the class: if its objective is to teach material as is (for memory retention) then the quizzes must be taken in class without access to resources, and represent the facts to be memorized. If the objective of the class is to enhance the judgment calls of the students, and their inferential capability, then the quizzes must present competing judgment calls to train their thought process.

When a teacher finds his or her quizzes out of balance, then the next lesson must compensate for the imbalance. Over-teaching must be responded to with easier, slower, more illustrated teaching, and under-teaching must be responded to with faster, tighter, more advanced teaching. Either case, the next quiz should show a result closer to the balance point. There are several possible dynamics: stable, unstable, and overly cautious options, in terms of the off-balance results of successive quizzes.

A teacher adhering to, and learning from the quiz-by-quiz feedback, will be able to exercise a series of teaching iterations that would sum up to improved teaching efficiency.

### Programming Level Specification

Some of the above methodologies are hereby reduced to programming level specificity:
Procedure A: grading students, or any knowledge-absorbing entity (as commonly designed using Artificial Intelligence). Human students or self-learning automata are treated with procedural sameness whereas in both cases it is important to supply motivation for the extra effort of learning a certain body of knowledge. The motivational grading is carried out via q questions, such that each question is presented with n answer-options, set about so that only one answer is regarded correct and the (n−1) others are regarded incorrect, by the “teacher” (the source of relevant knowledge, the grading authority). We assume for this procedure that there is no ambiguity with respect to which of the n answers is correct, and it is clearly determined by the recognized grading authority (the teacher). The procedure then calls for the graded student to mark for each of the q questions which is the right answer, (among the n answers presented), and communicate the markings for the purpose of grading, which can readily be automated as follows: grade=r/q, where r is the number of questions for which the correct answer was marked (0≦r≦q). By contrast to common grading, a grade less than perfect (r<q) in this procedure operates as an incentive for the student to keep thinking of the questions of the test because the student is only told his grade so far (r/q) without identifying which of the q questions was properly marked and which not, challenging the student to re-submit after thoughtful modifications of the answers. This re-thinking and re-evaluation of the questions is the great advantage of this method. After all the teacher wants the student to learn, not to just be graded. Without the re-submission a student who had right, say 80% of the answers would be happy and not keep trying to understand why he was in error for the 20% of questions in which he picked the wrong answer. Re-submission drives the student to re-think each of the q questions in the test, since she would not know which question she answered right and which one she answered wrong. The next step in the grading mechanism is to grade the 2^{nd} submission passed on from the student. The new, revised grade will be computed as follows:

g₂=(r₂/q)−p₂
where g₂ is the grade after the 2^{nd} submission, and where r₂ is the number of correct answers marked in the second submission, and where p₂ is a penalty designed to distinguish between achieving the same value of correct answers in the first round, and in the second round. [in percentage notation: g₂=100(r₂/q)−p₂].

For example: q=10 (10 questions), each associated with n=4 answers (which creates a field of 4¹⁰=1,048,576 possible answers for the test). In the first round the student marked 7 questions correct, and hence her grade will be g₁=r/q=7/10=70%. The student is not satisfied, and she reconsiders the test again, knowing that each question she answered has 70% chance to have been answered right, and 30% chance to have been answered incorrectly. Suppose that the student managed to correct 2 of the wrong answers, but with respect to a third answer she re-marked a right answer, this round marking a wrong one. In summary she will have 7−+2−1=8 correct answers, and if we determine that the penalty, p2 is 5 percentage points, then the revised grade will be:

g₂=100(r₂/q)−p₂=100*(8/10)−5=75%
So the student, Alice, improved her grade from 70% to 75%.

Alice, the student, is informed about her new grade, g₂, which now revises and replaces her original grade, g₁. But again, Alice does not know which two questions she answered wrong. And since the teacher would wish Alice to keep thinking about this matter, he would offer her, per this procedure, to submit again, albeit with a new penalty, p₃ to account for this re-submission privilege. Alice will now regard every one of her answers as associated with 80% chance for being correct, and 20% chance for being incorrect. To resubmit, Alice would need to, once again, re-think, and re-evaluate all her answers. She will be well motivated to do so, if the penalties for resubmission will be sufficiently low, so that she can substantially improve her grade. The procedure further allows the student to re-submit her answers to the test some t times, in succession, and for every submission round, i (1<i≦t) the calculated grade will be:

gᵢ=(rᵢ/q)−pᵢ,

where rᵢ is the number of correct answers marked in the i-th submission, and pᵢ is a penalty designed to distinguish between achieving the same value of correct answers (rᵢ=rᵢ₋₁) in the previous round. At some point the student (Alice) will stop the submission. The last grade achieved through the last submission will then become the final grade for that student on that test. The teacher may limit the time for resubmission per choice. It is clear that it may well happen that the number of correct answers in the last submission is the same, or less, than the number of correct answers in previous rounds. And that fact introduced a certain “gambling thrill” to the test procedure.

For example: Suppose that in the example above, Alice decided to submit a third time. She manages to correct one of the two incorrect answers, and loses the right answer to another question. Alice will have 8 correct answer, and with p₃=15 her grade will be:

g₃=100(r₃/q)−p₃=100*(8/10)−15=65%
Alice is now graded less than her original grade of 70%. Unhappy she gives it another shot and this time she answers everything correctly, r=10, right answers. With p₄=18 she scores:

g₄=100(r₄/q)−p₄=100*(10/10)−18=82%

which is her best grade from all her rounds. As a net result Alice enjoys a higher grade (82%) than her original score (70%), but what is more important, Alice has now wrestled with the material three times around, and kept with it until at this point she has the right answers (she knows!) to all the questions in the test.
Procedure A1: The same as procedure A with some specification as follows:

pᵢ=p₀*(i−1)

where i is the count of submission rounds of the test, and p₀ is the penalty increment that is added per round.
For example: for q=10, and r₁, r₂, r₃, r₄ are: 6, 5, 7, 9 and p₀=5, the corresponding grades will be: 60%, 45%, 60%, 75%
Procedure A2: In this procedure the teacher offers a stronger inventive for his student, Alice, to keep at it, and re-submit again and again, until she has all the answers right. To so incentivize Alice, the teacher needs to dangle a very good grade to reward the student who kept at it, until all the answers were correct. In one variation of this procedure the penalty pi for each round i will be pᵢ=rᵢ/q, for 0≦rᵢ<q, and pᵢ=p′₀(i−1) for r=q. Namely, the penalty for every submission where one or more answers are wrong is so high that it neutralizes the grade back to zero. However, when the student scores r=q then she logs a high grade commensurate with how many rounds she used to secure that score. Alternatively, for instance, the normal penalty as above will be used (see procedure A1), except that for r=q a considerably higher grade will be assigned.
For example: Alice, as above submit r₁, r₂, r₃, r₄ correspondingly: 5, 7, 9, 10, let p₀=10, and p′₀=3. Alice grades will be: g₁=50%, g₂=60%, g₃=70%, g₄=91% Had Alice stopped after the third submission she would have ended up with 70% as her final grade, instead of the much higher 91%. It's a win-win procedure.
Automation: the described grading system may be automated and carried out in a grading module on a network, and serve students posted as nodes on the Internet. This allows for instant grading and for around the clock service.

Summary: We propose testing and grading methods designed to calibrate teaching, and better engage the more lagging students—studying better the study material. This methods are good for face to face, and online teaching, whether asynchronous, or not, and are also useful for motivating AI entities to keep on with their self-learning effort.

### EXPLANATION OF THE DRAWINGS

FIG. 1: Interpreting Grades as a Teaching Feedback: four depictions, top down: in a balanced teaching the top students achieve a high score of (depicted as 100%), and fewer and fewer students achieve lower and lower grades. This means that more students absorbed the lessons taught than did not. And only few students achieve very low grades. In the second graph “over teaching”, more students secure low grades, and only a few scored above the bare minimum. This state of affairs indicates that the lesson was too hard, too obscure, the students did not absorb the material taught, and the teacher should repeat the lesson, and convey it slower, or with more details, or with more background explanations. The third depiction “Under Teaching” shows a crowding of the students around the high scores. This situation suggests that the teacher was teaching “the obvious”, proceeded to slow, or taught material the students already knew. Such up-side crowding suggests that the teacher should be more aggressive, faster, deeper in his or her or its teaching. The last depiction “poorly matched class” shows a combination of the over-teaching and under-teaching, it suggests that for some students the teaching is too simplistic, too easy, not challenging while to other students the same lesson is overbearing, and confusing. This suggests a poorly matched class where teaching faster and deeper will leave behind one group, while going easier will do injustice to the other group of the better conditioned students.

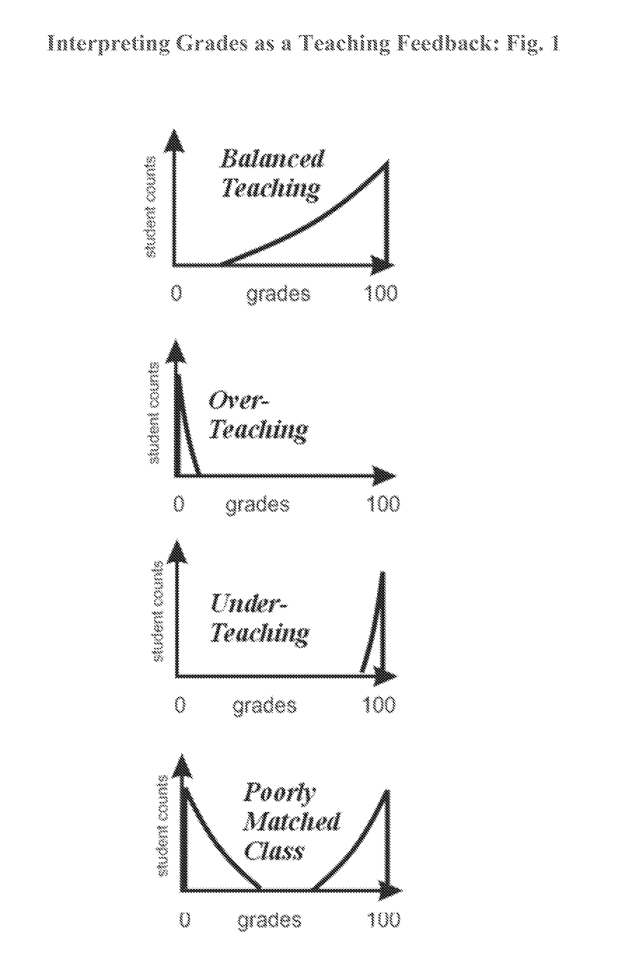

### DIGITAL CURRENCY PAYMENT REGIMEN

### Exercised Also in the Internet-of-Things and Between Other Non-Human Payer and Payee

### Payment-AI

Abstract: We persistently evolve into a “proxy reality” where artificial intelligence agents, avatars, robots, etc., are assuming an increasingly greater load of ordinary life, leaving humans to focus on matters reflecting the core of being human. Soon our refrigerator will realize that we run out of eggs, and order (and pay) for a dozen at the grocery store that sells eggs at the best price, at that moment; our smartphone will negotiate, and pay for a passing Wi-Fi session provided by some local source; our personal aid robot will automatically purchase the latest AI software to improve its services. To foster this vision, service providers will need to be paid. Since the request and supply of services will be happening between AI agents, we will need a suitable payment regimen for bidding, processing, transacting, and storing a universal currency. Digital currency is most suitable for this challenge. We offer here a preliminary description of digital currency payment regimen among AI agents.

### Introduction

It is the story of civilization. The wheel, the yoke, the sail, the steam engine—humans keep building contraptions which take over tasks and activities formerly labored by us. For some time now we have seen the latest wave in terms of artificial intelligence, and robotics. The present vision describes artificial intelligence (AI) agents fully interactive over the Internet Protocol (Internet of Things)—conversing, dealing, transacting, with ever greater sophistication and intelligence.

The way to foster and accelerate this vision is to insure a vibrant, versatile, convenient payment regimen so that service providers can readily be paid fair wages for the services provided. Fair Payment is the incentive that powers up successful human economies, and it is likely to be the cornerstone for the ‘Economy of Things’ (EoT).

Ahead we describe first the Internet of Things (IoT) payment environment, and then the principles of IOT payment.

### The IoT Payment Environment

Payment used to be person-to-person, human-to-human. It evolved into payment between people and organizations, and between organizations as such. More recently payment was exercised between humans and machines. E.g. ATM machines, vending machines. What we are facing now is the new modality: machine-to-machine.

The term ‘machine’ refers to any entity, which is not a human being, but which controls, stores, pays and gets paid money. Such a machine, or node (if it is an entity within a network) is assumed to be owned by a human being, or a human organization it serves, and it is assumed to be endowed with some measure of computer intelligence with which it can participate in the payment exercise.

A simple node will be programmed to release a measured amount of service when a specified amount of money is provided to it. It will deliver a song, an article, or open a gas pipe, or a power line, etc. A sophisticated node will bid, negotiate, haggle for an advantageous deal. In sum total, one envisions a global network with up to tens of billions of nodes, operating in strong mutual visibility, and therefore open to aggressive and creative, deals and payment arrangements'all conducted through the intelligence associated with the participating nodes.

The human owners of these nodes will just harvest the financial benefit earned for them by their smart nodes.

### IOT Payment Principles

Here are some of the operating principles of the envisioned IOT payment regimen:
Digital currency: today's prevailing payment mode: account based electronic transfer will have to give way to digital currency comprised of a binary string that carries value and identity.
Limitless Resolution: the paid digital currency could handle micro, even nano payments—small denominations as desired—and macro currency, as large a sum as necessary.
The payment protocol will include a conflict resolution authority to resolve disputes and payment impasse.
The payment environment will support any number of currencies and mints, and provide for a visible exchange rate between them.
An acceptable trust assigning entity will be established where owners of nodes would reflect their trust value onto their nodes.
The payment regimen will include an optional real-time taxation system to collect due taxes as they are being owed.

### Protocols

We offer here a basic categorization of planned node-to-node payment protocols:
Pre-programmed transactions, and parties, (T, P)
Pre-Programmed transactions, any parties (T)
Pre-Programmed parties, various transactions (P)
Conditional payments, (C)
Negotiated payments, (N)

In mode (T, P) a payer node, “npayer”, is transacting with a designated payee node, “npayee,” through a specified transaction. For example: a utility dispenser is fitted in a consumer home, and releases a measure of KWH of electricity, per a payment of a certain amount of dollars, paid from a “money stick” (the npayer) fitted onto the meter box. The parties are the same; the transactions are also the same.

In “pre programmed transactions” mode (T): a payment node is repeating the same transaction with a variety of counter nodes. For example: a virtual road tollbooth, charges a fixed toll from each car that passes by.

In “pre programmed parties mode” (P) a payment node is transacting with a pre set payment node, but the transactions may vary. For example, a smart refrigerator will transact with a preset grocery store to buy the produce that is under a pre set threshold today. The transaction party is fixed, but the order applies to varying items.

In “conditional payment mode” the parties may be fixed (C, P), or the transactions may be fixed (C, T), or both parties and transactions may be fixed (C, P, T), or alternatively neither parties nor transactions are predetermined (C). For example, a payee node controls a library of songs, which are sold, each at a designated price to many customers. The conditions for the payments are pre-programmed and may comprise any logical constraint. For example: time of day, a minimum amount, or a maximum amount for the transactions, the satisfaction of any number of terms or conditions, all represented as signals that can be read and processed by the node's computing power.

In “negotiated payment” (N), the node may be equipped with top notch AI logic and interact with a similarly smart node, or nodes in order to best support its declared objective, which is assumed to be the objective of the owner of the node. For example, a payer node wishes to send a large video file to three recipients. The node asks for bids. Three Internet connectivity providers receive this request, and each sends over a connectivity proposal: what would that connectivity provider charge for such a large file to be sent to three recipients. The payer node may choose the cheaper proposal out right, make or commit to the payment, and the transaction goes through. Alternatively the payer may show one proposal to another offeror to explore a matching policy. The payer node has no knowledge of the policy codified into the bidders. Perhaps the logic of one bidder says: match and improve upon any bona fide competitor up to a certain threshold. The paying node may be smart enough to wait to such time of the day when the offers are more attractive. The node may be as smart as the AI planner who installs it is. It may come with counter offers: give me a better price on these three, and I would commit to purchasing connectivity from you for the next six months. In other cases two payment nodes may decide to barter: one sells access, the other sells computational power.

It is assumed here that the transacted digital currency has means to avoid double spending, means to insure anonymity, and methods and means to insure validity of the money.

### Security

IoT payment environment is a very attractive target for cyber thieves. Since nodes are expected to house digital currency, they are vulnerable to theft of same.

We consider three methods to achieve the necessary security:
Access Security
Physical Security
Cryptographic Security.

Access security implies placing the node in a safe environment beyond the reach of the thieves. This is the case for nodes placed behind firewalls and physical protection. Nodes may also be housed in tamper resistant boxes, like the electronics in a vending machine. Physical security refers to securing the node itself with tamper resistant means. Such means may include ‘erasure’ option in response to attempts to crack the physical security. Cryptographic security is wide ranged from:
redemption security
storage security
transmittance security

Redemption security refers to means to restrict the redemption of the digital money such that a thief will find the money useless. Storage security refers to means to keep the stored money safe, through cipher, or through steganography. Transmittance security refers to smart dialogues between payee node and payer node to frustrate a thief trying to pose as either. All these methods may involve entrapment—catching a thief who is trying to use stolen nodes' money.

One generic security measure would involve spreading the money over a large number of nodes so that each node will carry a small amount of money—too small to warrant its individual cracking.

### Avatars

Along with a large variety of ‘dumb nodes’ the Internet of Things is expected to feature increasingly intelligent smart nodes comprised of AI-loaded entities, and advanced robotics. The more these increasingly human-like nodes (avatars) interact with each other, the more they will trade, haggle, and make business decisions in a human-like way, and they will do so over digital money they control.

The intrinsic trading advantage of the Internet is its wide ranged visibility. Billions of people, and a greater number of billions of devices (nodes) are in nearly complete visibility of each other. This implies that the needs of so many nodes may be supplied by providers from all over the globe, or by a combination thereto. To exercise such dealing flexibility, smart nodes will employ sophisticated algorithms, and advanced tools, like auctions, and timed bidding, allowing for multi participant smart deals where some long range promises will be traded against short range discounts, and vice versa. The smarter the AI contents within a node the more advantageous the deal that it would strike.

The full range of rational and emotional considerations employed by people as they plunge into the marketplace, and offer service, merchandise, or cash, may gradually and over time be mimicked by artificial intelligence, (AI), constructs. Human beings cannot handle a large, multi billion nodes, marketplace, and will restrict themselves to a handful of players among which to develop a most beneficial deal. However, AI agents don't get confused by a multitude of offerors and a multitude of deal options, and they can sort out through a large variety of the same, and come up with a most advantageous deal. In other words, the much celebrated mutual advantages of a free marketplace will be manifold upgraded by allowing AI agents to represent their human owner, and they will plunge into the marketplace, and sift through the various relevant offers, and counter offers. There is no visible limit to how sophisticated and how powerful those deal making programs can be. Their presence will bring to bear the full exchange and commercial capability in the global village.

The most powerful use of such AI capability is expected to apply to the emerging global knowledge marketplace. In it AI agents will hunt and pay for a most relevant answer to the questions raised by their human masters. Today, a lot of global information is supplied freely by search engines and alike. This is because there is no effective mechanism to charge for it, and because of inertia in which such services were always supplied free. The purveyors of the knowledge get paid via an annoying advertising campaign that is thrust forward as a price of using the service. However, by establishing a fair pay platform, the players (the people who surf and use the Internet) will be properly motivated to invest in knowledge services, and continually improve the service to the consumer. The digital currency environment will enable to application of the principles of a free marketplace to a most powerful knowledge marketplace.

This vision of advanced AI agents packed with deal-making software is marked with a crucial question of who exactly is behind the various rules, preferences, and objectives that govern the AI procedures that eventually close the deals?

This question of Deal-Making Control deserves a few words.

### Deal-Making Control

When free wheeling Alice buys or sells something to Bob, then Alice is her own master, she decides on a deal she prefers, and has no one to account for, or to justify her decision to. But if Alice works for a company, she has to account for her deal-making decision and report as to how consistent she is with the instructions imposed on her. Similarly an AI agent employing a complex set of priorities, preferences, and objectives, has to account to its owner, and justify its decision. The owner could be a higher up AI agent, or it could be a human being. In either case we may identify two modes:
No Abstraction Mode
Abstraction Mode

In the former, the ‘owner’ of the AI agent passes on to the agent the specific code and logic to be applied in closing a deal. Everything that the dealing agent knows was delivered to it from its master (whether human or another AI agent). In that case the master could review the process leading to the deal making decision, and verify that it is a bona fide application of the code that was passed down to that agent. Only in case of some fraud, a hacking event, or an error will there be a problem. This is called the ‘no abstraction mode’ because the higher up node, or human, has the same specific view of the deal making intelligence as the dealmaker agent itself.

In the abstraction mode, the higher up node is issuing more abstract guidance, which the lower (deal making) node is interpreting and using to develop specific code and logic. In that case it is important for the higher up node to verify that a deal executed by the lower node was consistent with the abstract instructions given to it. In other words, it is important to verify that the abstract guidance was faithfully interpreted by the lower node. If not, then the lower node will have to re-do its interpretation of the guidance so that its deals will reflect the given abstraction.

There is a great advantage to the abstraction mode because it can be applied iteratively such that higher and higher up node handle the challenge in greater and greater abstraction, shielded from the multitude of details that are actually used in executing a search for an optimal deal.

Of special interest is the case where the higher up node is a human being. It is desirable to allow the human owner of an AI node to determine the degree of abstraction he or she would like to use in guiding the node. Guiding principles may look like:
for a commodity, buy the cheapest offering
for a commodity buy the median offering between the most expensive and cheapest.
Buy non-commodity items only from national brand names
don't buy from a vendor that has been black listed by some mentioned consumer organization.

And such like.

### Node Hierarchy

Digital money being a binary sequence is stored in an area managed and being part of a node in the IoT, or in a comparable network. Such money is regarded as associated with the managing node. We designate m(x) the money associated with node x.

If a node y is defined to have ‘money ownership’ over node x, then y claims m(x) as its own, and if y owns no other node then the money credited to y, m(y), then node y has at its disposal the amount: M(y)=m(y)+m(x). If another node z has a ‘money ownership’ relationship with y, and y only then we may write:

M(z)=m(z)+M(y)=m(z)+m(x)+m(y)

We regard money ownership as akin to a hierarchy in as much as no node will have two parents and no two money owners. Accordingly, we may regard the network of nodes as comprised of several trees. Also, mimicking human structure, we envision a money nodes hierarchy. A parent node P will have a ‘parental’ money relationship towards its n children C1, C2, . . . Cn. This relationship will imply that the money credited to P is:

M(P)=m(P)+M(C1)+M(C2)+M(Cn)

For any tree in the network the root is credited with the sum total of the tree nodes.

A money parent node may remove money from its child node, or add to it without violating and changing the ownership accounting, which is only monitored from the outside as far as the tree roots are concerned.

This freedom will allow parental nodes which are located in a safe location to feed small amounts of money to children nodes to have money for their current payments. And conversely when a “line node” is paid more than a threshold amount of money, such money is taken away from it, to increase security perhaps.

### Man-Machine Relationship

Eventually root nodes are associated with a human owner. There are common cryptographic ways for ownership to be asserted. Human owners will have to prime the network, by loading the nodes they own with money, and human owners will reap the benefit from the nodes trades and claim the money accumulated within their nodes.

It is possible to make the identity of the human owner exposed, or make it confidential, and expressed only through ownership of a private key. This potential privacy may be critical for transactions where the parties may wish to remain anonymous. Since taxation may be built into the network so that any payment from node to node will have to be cut by a prescribed measure to account for the prevailing tax law, then the privacy argument will survive the counter claim that anonymity and privacy will allow for tax evasion. The tax authorities will not know whom they are taxing, but they will get their legal share all the same. And while so, individuals would find it possible to ask embarrassing questions, raise sensitive concerns, all the while knowledgeable and helpful people could offer advice and ideas without betraying their own identity, yet displaying a trust-worthiness award given to them per their virtual identity. This will allow a lot of good to be done to a lot of people.

### Network Money

A network like the IoT may establish a network currency for itself or for a well defined part thereof. Participants will buy that currency with the currency they operate, and then use the network currency for all payments throughout the network. This option will allow a network to adopt a digital currency of choice, one with security and protocols that are deemed preferred and that prevail throughout the network.

### The Economy of Things

The money transactions between ‘things’ in a network like the ‘internet of Things’ will mature to mimic the complexities and sophistication of transactions between humans. We will see a credit market, stocks investments, etc.

### Platform Notes

The prevailing platform for IOT trade will have to allow for:
Currency Exchange
Trust Designation
Dispute Resolution
Emergency Management.

### Currency Exchange

One would expect a variety of mints to prevail in the global village, and on its face this would hamper the vision of cross village pay ability. To handle this challenge, the global village will have to feature high transparency, delocalized exchange centers where various currencies can be exchanged per a well-known, and highly visible exchange rate. There would be no arbitrage—total global visibility. Albeit, the exchange rates themselves may be determined by a free market, or by authoritative decree, as the case many be. As long as the exchange centers are visible and well defined, the global payability from any npayer to any npayee is maintained.

### Trust Designation

The requirement to effect payment instantly and without delay is inconsistent with a requirement to validate via a third party and a special operation any passed payment. It is therefore advantageous to establish a trust mechanism by which an npayee will be able to trust the payer node, and accept its money as valid. The IoT payment platform will need to be associated with a trust mechanism that will allow nodes to claim a widely recognized measure of trust in order to participate in fast transactions not authorized real time by a third party.

Such trust mechanism may be based on the mint issuing a trust tag based on the behavior of each node over a long time, or on a total visibility of the transactions and a list that identifies all the nodes that have been cheating in the past.

### Dispute Resolution

Dispute Resolution mechanism is necessary to resolve payer-payee disputes. The mechanism will be based on established rules, and administered by the prevailing mints or by an abiding central organization. The dispute resolution service might include escrow services and holding disputed sums in limbo.

### Emergency Management

Any large public payment system is susceptible to all possible sorts of panic behavior, where prices change rapidly and people stand to lose fortunes. The IOT payment environment will have to establish some crisis management rules and authorities to provide for tools and means to handle such a challenge.

### Count Down to Payment Explosion

When you think about payment you think about lady Suzy handing over a bunch of dollar bills, or Uncle Jimmy sliding a credit card in a slit. Most payments today look this way. But that is about to change, and in a fundamental way.

One of the powerful attributes of digital money is that it divides to any resolution, however small, and that you never have to count change. You can pay someone say, $0.001. Now who would bother with such a tiny payment? Nobody today perhaps, but lets open a door for tomorrow.

So much on the Net is free today: Google is free, email is free, YouTube is free, free advice is free—we are getting used to it, but who is paying for our free lunch? The free service provider gets paid from a third party, say, an advertiser, and naturally caters to this third party payer, rather than to its audience. More than a quarter of a million of Google servers are at your fingertips whenever you click a search. 24/7 these servers crawl through the entire Internet, and cross-index their harvest. The relevant information you get on your screen in a split second, a 20th century President of United States could not get in hours. So why complain? Well, the basic economic truth is that whenever you get ‘free stuff’, you do in fact pay for it, but with a hidden currency and for an unwritten amount. Free search subdues topic-specific search engines that must charge to survive. Free search costs you through its skewed ranking of the results. You eventually overlook your best store for your needs; you remain clueless of a high quality convenient supplier for what you are after—simply because of how Google ranked its result. ‘Free content’ online magazines are another example. Wouldn't you prefer to pay a couple of cents per page free of the popping ads? And when your computer is idle, you probably would not mind for it to process data against a fair pay, for some extra cash.

With digital cash your computer or phone will micro and nano pay per your policy instructions, but without bothering you for the actual transaction. Real time transactions between strangers, or between their computing machines rather, will pervade the scene. Ad hoc internet connectivity services, quick charging of electrical car, per minute pay for first class online lectures, chat advise, revived Napster—peer to peer, paid, music and video distribution. Cars may pay real time for exceeding speed limits, and auto-pay per time of using a high-speed lane. Envision a tomorrow when individuals provide what they can uniquely offer to anyone on the planet who is uniquely in need of the same, anonymously, efficiently, without human intervention in the money transfer and at any small denomination. You will give a list of opportune purchase items to your phone, which will independently follow on sales and price fluctuations to pounce, order, and pay when the price is right.

Yesterday a letter writer had to fetch an envelope, fold and insert his letter to it, lick it, affix a stamp, walk to the “blue box”, and then return home. Today, you click your email, and your message gets there instantly. Similarly the laborious payment process of today when you and the other party mutually identify yourselves, then carry out a fraud prone ritual, will be minimized. For the majority of payments, humans will determine policy and preference; rarely participate in the payment dialogue.

Convenience is not the major benefit expected from the explosion of frictionless payment: the big boon is the creation of fertile grounds for individuals and groups to invest in high quality products and services to be offered on the global village. If you can solve a problem and you live at the end of the world, you could offer your solution and get paid for it by your client who resides twelve time zones away—without the effort of making acquaintance, like a stranger paying for a subway ride. The empowerment and the prosperity generated by the simple process of supply and demand—the process that gave us our prosperity in the “old space”—will be reapplied in cyberspace.

Computers are much faster than humans, ad-hoc micro denomination transactions are much more numerous than our today's regimen—as a result the number of transactions will multiply—an “explosion”.

In retrospect one will say, the Global Village was not the Global Village until any node in the network, any computing device online, could pay to any other computing device online, instantly, and without per transaction human intervention.

### Fair Pay v. Free: Why the Instinctive Choice is Wrong

Fair or unfair pay is never as good as free—what's more plain than that? Here is the short answer: if you receive anything of value without paying for it, then someone else is making that payment, and becomes your creditor while you are burdened with a debt, which may not be recorded in any court enforced contract but nonetheless debt it is, slavery in the broad sense: freedom it is not.

The free man, or woman is he who pays for what he receives, so that if he (or she) and the giver separate ways from now on—they experience no mutual obligation. The unowing man can say goodbye to his society at any moment, and present himself to another group without pre demands.

### Algorithmic Shopping

Shopping is an emotional experience, and shops play us, lure us, and make us shop and pay against any and all rationality, only that technology is about to redraw the battleground. The biggest impact will be felt by background commodities. No one gets overly excited about buying eggs or hauling milk, we just wish not to run out of either. Our future fridge will take care of that. Realizing via RFID tags that there remains only few eggs on the egg tray, the refrigerator—a node in the Internet of Things—will ‘shop around’ and request for bids from all local grocery stores who will be hunting for online orders. The bids will be analyzed according to the preferences given to the fridge by his human master, quickly deciding on the most attractive offer. The artificial intelligence in the refrigerator will be smart enough to postpone its order if no offer is good enough, while the stock of eggs is still high enough. The fridge will pay in advance for the order with digital money, no credit cards, no monthly statements, no invoices. Think about it: the decision to make a payment is relegated to an artificially intelligent entity!

In the near future you will instruct your avatar to buy new sets of white sheets, and light blue towels. It would be a no rush order, the old sheets and towels are still serviceable. Your intelligent avatar will exploit this ‘no rush’ instruction. It will hunt patiently for a coming sale and pounce in the appropriate moment, pay, and order home delivery. Unlike you, the avatar has no emotional ties with a particular store, or a particular brand, among equal quality options; the avatar is not influenced by parking considerations, location or traffic jams. The avatar's decision is not skewed by irrational brand loyalty, nor tilted by store loyalty (unless so instructed). It is simply price and terms: Digital payments made algorithmically, logically, and serving the interests of its owner.

What will vendors do? They will have to adapt to the new ‘decision maker’, and attract buyers via algorithmic discounts. Since their offer will be evaluated by smart intelligence, it can itself be smart and involved. Today vendors say: “Buy one get one free!”—easy to understand. They don't offer: “Buy one of this, and two of the other, and pre-order a third item, while allowing us to deliver it only two days from now, then we will pay you back 44.25% of your purchase, using digital loyalty money good in this store, and in the gas station near your home”. Such an offer will be impossible for a customer walking down the isle to evaluate, but your avatar would rate its attraction forth with, compare it to the convoluted offers placed by the competitors, and decide which way to go.

The pure rationality of this process will allow merchants to get rid of a superfluous stock in an easy and predictable way—enhancing efficiency. Freshness data will be delivered to the avatar for rational consideration. Some consumers will opt for a nice discount for a somewhat older product. Each avatar will be programmed to serve its human owner preference. Garbage cans will be equipped with RFID readers, communicating to a house-keeper avatar how fast food items are consumed, and optionally sharing this consumption rate with local groceries, which will be challenged to offer the house-keeper avatar a package with all the foodstuff that the household is running low on—immediate delivery, attractive price.

Today it's the habit, the pleasing ambience, and personal attention that create store loyalty. As shopping becomes increasingly algorithmic, loyalty will be generated via loyalty money through various broad coalitions. Avatars and smartphones will be loaded with such loyalty money, payable under various terms and conditions, with various expiration dates—usable by a strictly logical order, as exercised by the avatar.

Today we run our wallet for every dollar and every cent we spend. We count change, we pull a payment card, time and time again. It's just a matter of time until somewhere, somehow, our payment card is compromised and we become victimized. This specter will be viewed with puzzlement and empathy in the rear-view mirror by next generation of consumers who will load an avatar with digital cash, and pay no more attention for convenience commodities.

The most worrisome is the case is when you receive more and more free stuff and no creditor shows up. You may be paying your creditor in ways you are not aware of, or he is ready to pounce at you with his debt statement interest compound.

No reason why I can ask Google questions and get answers for free? I wish to pay for the service, may be 1/1000 of a cent, but pay nonetheless. My payment gives me rights to demand certain quality and certain features from the product.

### Micropayment and CyberSecurity—the “Toll Road” Solution

Cities and municipalities found a way to harness the private sector to build transportation infrastructure by allowing the builder to charge tall from each passing driver. Today, solutions like Easy-Pass perform frictionless toll payment from each speeding car. And in addition to such smooth payment, this solution also became an effective means of tracking cars as they roam the land. A similar solution may be applied to computing. As network users roam the resources of the network they may be asked to pay-as-you-go each time they tap a resource, or make use of a commodity, be it access, be it retrieved information, be it a storage location for information, be it a processing algorithm big or small. The payment can be accomplished by allowing each user per its computerized identity to own and move about with digital currency that may be divided to any high resolution desired. Any service available to the user will post its price for the service. The money will be paid real time, usually in counter-flow to any digital goods. So, results from a search engine will be flowing to the reader as the reader releases digital money in the opposite direction.

Such micro payment can be implemented with perfect anonymity where the payee only verifies the money as bona fide, and does not concern itself with the identity of the payer, but it can also be exercised with strict identity exposition. So only money associated with a particular payer will pass as bona fide payment. This will require all the network users to prepay and load up with digital money that identifies them as the payer. The history of such payment where the identity of the payer is recorded, provides for a natural tracking report on where the user has been. By selling say, money that is good only for a day, each user, automatically will have to repurchase, or be daily re-supplied with money to carry out computing tasks in that day. Hence anyone who loses his network access will be out of the game the next day. This tracking mechanism will also put serious hurdles before hackers and data thieves. They will need either to deceive the mint, and pay with fake money, or they will have to steal good money from a user and pay with it. This high resolution payment regimen is tantamount to requiring a password credentials every step of the way, with one advantage a password repeats itself digital money bits are different for every micropayment, and any deviation from what is expected by the mint will be readily discovered.

In closed systems money for micro computing services may be allocated by the system administrator. Such allocation gives power to the administrator to allocate computing resources according to expected needs. So, low level users of the system will be allocated a small amount of money to use in their roaming through the system, and if they need more they will have to request it, identify themselves, and explain why they need so much. This will be equivalent to graded access, where many users who are not expected to use the network and the system at any great depth, or any great complexity will be granted limited service options, simply by allocating to them small measure of daily “money”. Others, more trusted, with higher security clearance perhaps will be given higher budgets for more involved usage.

Consider commercial websites luring the public to surf and search. Such website could allow free roaming through its pages, but any user who wishes to execute a query, request report, data, a particular answer to a question, will have to pay for it. Now the payment may be made so miniscule that no one will mind, but if the payment must be made with money tethered to a particular owner, then regardless of the amount paid the identity of the browser is flashed out. On the other hand such payment will serve as an incentive for building very responsive and useful response mechanism to common queries.

### Payment Protocols

Computer users will purchase or will be given a measure of digital money that runs like a string of bits. The money may be housed in an external device like a USB stick to allow the user to pay from any computer she happens to use, or it may be housed inside a personal computer. At will the user will set forth a request for service from a computer system. The system will respond with availability statement plus cost statement, and credentials requirements, if any. The service user will be able to reject the price (and the service) if deemed too high, or accept it otherwise, and send forth its credentials. If the credentials are accepted (and the cost too) then the service provider will exercise an exchange protocol with the service user. The protocol will determine up to micropayment resolution what amount should be paid at which state of provided service. Since digital money can be paid at any high resolution desired, it would be possible to splice both the service and the money to any small parts as desired, and so de factor make the payment counter-parallel and real time with the delivery of the services. The service provider, in parallel of being paid and providing the request service will turn to a money verifier and request to verify the money bits as bona fide. If not, the service will stop right away. The verifier of the money may be a local agent that is asynchronically connected with the mint that is ultimate authority on whether the money is kosher.

The payment protocol will also cover the case of multiple payees. The requested service may be comprised of platform availability, commodity services and tailored services. Each of these services is being provided by a different economic unit. The price paid by the user will be the sum of the payments claimed by the different service provider. The protocol will designate one provider as the point of contact, collection and distribution.

The service paid for with digital money may be small cuts of media, be it print media, audio media or video media. This will allow media outlets to offer a page for a small reading fee, offer a video for a few cents and provide this media without any interference from advertisement pop ups as it is done today.

The instant payment for computer services will eliminate, or alleviate the need for subscription fees, which are inherently unfair since the heavy users are subsidized by the light users. It would be pay as you go at high resolution. No accounts, no settlement, no invoices, no collection, and controlled anonymity.

One issue that can be readily resolved with the pay per computer and communication services, is the issue of throughput. A bit-pusher will be able to secure higher bit throughout for his media by paying nodes on the road (hubs) to prioritize its bits over others.

Today the super large organizations can offer a variety of services for free (e.g. email services, search services) since they get paid with the accumulated value of the data of their many million subscribers. This “free” level of services serves as a barrier to new comers, to start-ups who may have a better value idea, but are unable to charge a public pampered on ‘free’. The pay per service will enable the government to compel such free-service organizations to charge, say, taxes their users. Once people pay for a service they will readily look at paying a bit more to get more value, and new comers will have new chance to thrive.

### Double-Anonymous Knowledge Marketplace Architecture (DAKMA)

Double-Anonymous digital currency enables unprecedented knowledge dissemination, and knowledge exploitation, accelerating prosperity, alleviating unwholesome social imbalance.

Seeking knowledge and answers today is a process limited by whom you know, and who you can reach. Hence, the wealthy and well connected readily acquire the knowledge they need, and further increase their advantage over the rest of us. The proposed Double-Anonymous Knowledge Marketplace architecture (DAKMA) describes a network protocol that enables knowledge dissemination and sharing access throughout the network, thereby contributing towards a leveled knowledge playing field, so that people compete with ingenuity, energy and persistence, not on unfair knowledge-access advantage.

Individuals, organizations and artificial intelligence (AI) agents are represented through ‘masks’, retaining their anonymity whether they are knowledge seekers, or knowledge givers. The virtual knowledge givers establish their credentials based on their performance. Network majority is used to regulate traffic, vouch for credibility and track record. Knowledge junctions, for filtering and scope management are freely established. Repeat or similar answers are captured through AI agents, and thereby multiply the impact of the most knowledgeable.

DAKMA is powered by anonymous digital currency, motivating a healthy competition for knowledge services, and a resultant ongoing improvement and efficiency. A paid framework will create competitive pressures for lower prices, and greater affordability. A knowledge possessor will make more money if he or she sells the same knowledge to more people—by lowering prices. The net result is wider spread of the knowledge of humanity—a more leveled playing field that would allow the talented, creative and ingenious among us, who now are limited by their wealth and connections, to bring to bear their talent and ability, for the benefit of all.

### Introduction

We can distinguish between knowledge per se, KPSe, and knowledge per solution, KPSo. KPse is any set of truthful facts and logical relationships regardless of their utility. KPSo is a set of facts and logical relationships, which contribute to finding and executing a solution to a relevant problem or challenge.

It is easy to gather KPSe since data is everywhere, and facts abound. It is difficult to find and acquire knowledge that would help one solve a given issue or challenge. In fact, the lion share of the effort of problem solving is devoted to digging out the information, data and knowledge necessary for a solution. The Internet is very helpful to many of us because advanced search engines will dig out far away information of relevance for our issue at hand. It also helps identifying experts and mavens for us to contact to help us find a solution.

Regarding the search engines, they are paid by advertisers and hence they wish to increase the number of ‘searches’, which is different from making the searches more efficient. For example, if a given person is ‘searched for’ through a given search engine, then the engines will push up sensational items regarding that person and suppress credible information that is more “boring” like his or her credentials for a given topic. If a given expert goes through a divorce, then the divorce public court papers will feature promptly as a “juicy” stuff. We consider here a pay mechanism by which the recipient of the search results will pay for the services rendered to him or her. The search engines will then opt and compete to serve the paying client—the user of their search results. This will open a campaign of innovation to learn about the needs of the searchers in order to serve him better—and be paid by him.

For knowledge that is not ready to be realized, and it is not just a matter of digging it out from the vast data ocean of the Internet, but rather needs to be extracted through a dialogue from a source, new efficiencies will be realized via a vibrant payment system. Seekers of knowledge and information will be able to express the intensity and the criticality of their need through how much they offer to pay for the right knowledge or information, while mavens and experts competing for business will offer their knowledge ware for increasingly competitive prices. The Internet will offer visibility on a global scale, to effect and leverage the competition to its maximum.

Since the majority of questions asked by people are of a repetitive nature, what Alice seeks, is quite similar to what Bob wants to know, then there will be room to capture answers to popular questions and provide them for a much better price. A variety of software solutions will be established to package such knowledge.

Knowledge will be traded also among AI agents (AI—artificial intelligence), avatars, and robots, exercising negotiating, and haggling protocols of ever increasing sophistication.

### Knowledge Exchange Currency

In order to expand the knowledge trade Internet wide it would be of advantage to trade with a network currency that would in turn be purchased, by each via his or her customary and prevailing currency. This knowledge trade currency (KTC) will serve as a global clearing house for international trade.

It is of great advantage to use digital currency for the knowledge trade, and allow the money to flow on a pay-as-you-go basis with the knowledge served. This will be important because the majority of ‘answers’ will be simple enough and cost little. That means that it would be very uneconomical to invoice, and chase debtors.

### Anonymity

Seekers of knowledge and information are very often interested in anonymity lest the very fact that they seek a particular piece of knowledge will reflect ill on them (for good or bad reason). Knowledge providers often seek anonymity in order not to become target for coercion and blackmail from people wishing to pick their brain, and perhaps because the piece of advice they give is not well received by the powers that be.

Anonymity in both describing a problem and in describing a solution will increase truthfulness, transparency, frankness, and openness—and hence will attract more helpful solutions and advice.

By using a proper digital currency anonymity on both sides may be preserved.

Questions and issues which are not ad-hoc and require an extended picture can be handled via virtual identities, or avatars where the answer giver would know the entire history of the question asker, since the same avatar (mask) asked the various questions, but would not know who is the actual person represented by that avatar.

### Knowledge Middleman

People are sufficiently alike that most of what they ask has been asked—and answered before. This leads the way to a smart knowledge-packaging program that would serve as the middleman between the knowledge source and the knowledge demand. Mathematical techniques like multi variate analysis and big data do play a big role in constructing these solutions.

### Implications & Scenarios

The reality where a given answer will satisfy many question askers will eventually lead to cost reduction for the latter. This will reduce the distinction between those who have more money and more connections and the rest of humanity. Meaning, the talented will have access to the information and knowledge they need to exploit their abilities, and help society at large.

### Illustration: Medical Knowledge

Because we all share the same biology there are a great number of us who share the same medical condition and need to be guided by the same therapeutical knowledge. A well designed knowledge dissemination and knowledge-packaging solution will leverage the common knowledge to all who need it.

Suppose that among the 7 billions people on earth, 0.1% suffer from a certain disorder, namely 7 million of us. 10% of the sufferers share similar age and environmental conditions: 700,000. And 10% of them share the same combination of constraints in terms of other present diseases and disorders. This implies that 70,000 people on earth could be helped by a medical answer and guidance that was originally given, say only to 7000 patients who consulted a doctor. The remaining 63,000 people could be served by a knowledge-packaging program that charges them much less than the live doctor does.

### Knowledge Exchange Protocols

Framework Protocol: using any common classification system for knowledge (like the SIC code, or the Dewey classification used in libraries), the various knowledge issues will be charted (fitted) on that knowledge framework. The charting can be done individually by the knowledge seekers (the question presenters), and by the knowledge offerors (the answers givers). Or alternatively dedicated classification centers will provide this classification service. The idea being, to allow the human query presenter to style his question in a short simple way consistent with how she would pose this question to a knowledgeable entity who knows her. This knowledge of the question presenter is crucial for the purpose of understanding how to resolve equivocation in the phrased question. Without such interpretation of the question, a ‘dumb’ search engine will collect answers from all sources that mention the cited words, regardless of their meaning and context. The dedicated classification centers, or say ‘the interpreters’ will provide this service to question presenter. The presenters will inform the Interpreter about their interest and disposition to allow AI engines to infer about the intended nature of the question. The exposure of the query-presenter to the Interpreter may be via a private/public key arrangement (a mask) so that the Interpreter does not know the actual identity of the client, yet, it knows sufficient about him or her to carry out an accurate interpretation of the laconic question posed by him or her. The output of the Interpreter is the same question or query posted by the human question presenter but in a more elaborate form that clearly identifies the subject matter environment and the exact intent of the question. The Interpreter will then post this elaborate question in a knowledge-cell within the knowledge fabric, with as much specificity as possible. The knowledge fabric is the hierarchical classification of knowledge, and based on the clarity and specificity of the original query, its elaborate version can be posted in a properly elaborate cell (definition of perimeters of knowledge).

Sources of knowledge, on their parts, will identify the knowledge perimeter for which they deem themselves knowledgeable and competent, and post their knowledge claim at the highest cell in the knowledge fabric that represents their claimed expertise. So while the question post will seek the lowest (highest resolution, highest definition) cell fitting their question, the knowledge source will post its claim in the highest fitting cell.

One may envision q questions presenters peppering the knowledge fabric with their questions, while a answer sources planting their claims over the same knowledge fabric.

A pairing algorithm that takes into consideration the following factors then carries out the pairing of questions and answers: (1) the distance between a particular question and a particular answer source, where the distance is measured on the network in any of the customary node-to-node distance measuring; (2) the transactional match between the question source and the answer source; (3) any pairing history either between the particular question source and the particular answer source, or between the class of the question source and the class of the answers source.

Transactional Match: And question source associates with its question an amount of digital money to be paid for the service of providing an answer that claims to be satisfactory. This is question payment offer (QPO). The digital money is attached, trails the question. When the question is taken up by the Interpreter, it cuts from the QPO sum its own service pay to be compensated for elaborating on the original question, and for its services of posting the question in the fabric.

The answers source on its part attaches to its declaration of relevant knowledge a price statement that would identify by some established code, how much that knowledge source will charge for its answers.

The pairing algorithm run by the fabric custodian, and charging both the question source and the answer source for its services, will evaluate the match between what the question source is willing to pay for the answer, and what the answers source is willing to sell his, her, or its knowledge for.

The pairing algorithm will co-evaluate a set of q questions and a set of a answers to pair them in a non exclusive manner, namely each question may be paired with several answers and vice versa, each answer may be paired with several questions. No question will remain without identifying at least one most fitting answer (among the available a answers), and no answer will remain without pairing it at least with one most fitting question.

Transactional History: that is the record of whether this pair or question presenter, and answer giver had a fruitful relationship in the past, or whether each represents a category that had successful relationship with sources of the same category on the opposite side.

Once paired the question source and the answer source will be able to launch a negotiation to agree on terms. For example, the answer source might quote a price with ‘satisfaction guaranteed’, such that nothing is being paid if the answer is not satisfactory, or quote another (probably lower) price for “as is”, payable whether it is helpful or not. Once the terms are agreed the answer source is forwarding the answer.

### Human Sources and Artificial Intelligence

The protocol is designed to allow for seamless switch from human intelligence to artificial intelligence and back. The more generic, and the more common a question, the more it is suitable for an AI response. Answers sources may be humanly online ready to submit an answer, share their knowledge, or they may over time feed their knowledge into an AI inference engine that would in turn pass their knowledge to questions presenters.

History Powered: this knowledge sharing paradigm may be very conveniently history powered. A question sources Qi may have a successful response history from answers source Aj, and this history will be accessible to the pairing algorithm either through a dedicated database or through a trailer on either Aj or Qi, or both.

This will be the incentive for a question presenter to attest to satisfaction of an answer.

Testing: A question source may be testing potential answers presenters by asking questions for which the answer is known to the question presenter. This knowledge will allow one to check and evaluate the response of the answers source, and determine the credibility of the source.

Certification: in some areas of knowledge consumer (knowledge seekers) may wish to ascertain a threshold level of competence on the part of the answers giver. An appropriate certificate may be presented by the answers source without identifying their identity. There are common cryptographic public/private keys protocols allowing one to do so. So a seeker of medical knowledge will be able to examine a certificate of “being MD” on the part of the answers source.

Peer to Peer Dissemination: Once a knowledge seeker receives a satisfactory answer to a question, then this knowledge seeker may use the purchased knowledge to sell the same. So the former question presenter may now present himself or herself, or itself as an answers giver. This may repeat itself, creating a situation where common questions are responded to very quickly by the growing community who asked the same or very similar question before.

### Validation Protocols

Given the certification options and the accumulated history of good answers, still there is a substantial lingering uncertainty as to the validity and propriety of a given answer, mainly because of the double anonymity of the process. One way to validate the answers is to request the answers source to identify himself or herself with all their credentials. Another way, was mentioned above, in the form of testing with questions for which the answers are known. Another method is to form a validation question from the answer given, and request other answers source to validate or invalidate the recorded answer.

The question source may consult and pay a few, s, answers source, then list all the received answers and define a question as to the ranking or as to prioritizing of the listed answers. A clear cut question to sort out between two different answers given to the same question is to pose a question: which answer is preferred. One could then count how many answers sources preferred one or the other.

Double Appearance: each of us is ignorant about different things, so the most successful answers source has issues and questions for which she needs another answer source, and the most ignorance question presenter may have an area of knowledge however narrow, however unpopular for which she can offer an answer. So each human or AI entity will have double appearance in this knowledge exchange marketplace, once as a questions source and another as an answer source.

Price Dynamics: common, recurrent, generic questions will over time have a larger and larger community of sources of answers to these questions, given that every question source that got the answer to his question will readily turn an answers source for the same. As the community of answers source grows, then by the basic laws of economics, the price of the answer will come down.

By contrast questions that require highly tailored answers will over time identify a small cadre of answers givers who developed a record of efficacy. Yet, since the answers they got are not generic, and hence not transferrable the only way for another question source to tap that knowledge is to go to the very same sources that built a name for themselves. These highly successful small cadre of answers source will be able to raise prices to handle the load (the queue).

Topical knowledge-marketplace systems: The marketplace exchange described above is generic and may be built to apply to all forms and extent of human knowledge. Alongside it, one could construct topic specific knowledge exchange systems. For example a knowledge exchange system for medical issues. The answer sources will all be certified physicians, and the system will only entertain medical questions.

Interpretation Questions: An answer may be given in a narrative which uses concepts and terms which are alien to the question presenter. In that case the question presenter will mark the un-understood terms for launching a question: what is the meaning of term x. And so with respect to all other terms in the answer that were not clear to the question presenter. If the reply to these interpretation request question comes, again, with unexplained terms that are unknown to the question presenter, then the above process iterates, and the terms un-understood in the interpretive question, and sent off to the knowledge market place to be elucidated and explained. This iteration may repeat as many times as necessary. This process allows anyone to keep probing the knowledge of the system and acquire all the background knowledge needed for him or her to comprehend the answer to the their original question.

Efficiency of top Answers Source: this exchange marketplace will keep each answer source busy with the top questions he or she or it can answer, because the simpler questions will be handled by those who probed the top answers source before, and they can now disseminate them further without bothering the ‘guru’,

[symbol]

What is claimed is:

1. a method for grading students, or any knowledge-absorbing entity (as commonly designed using Artificial Intelligence) via q questions, such that each question is presented with n answer-options, set about so that only one answer is regarded correct and the (n−1) others are regarded incorrect, by the “teacher” (the source of relevant knowledge, the grading authority), and where the graded student will mark for each of the q questions which is the right answer, (among the n answers presented), and communicate the markings for the purpose of grading, which can readily be automated as follows: grade=r/q, where r is the number of questions for which the correct answer was marked (0≦r≦q); in contrast to common grading, a grade less than perfect (r<q) in this method operates as an incentive for the student to keep thinking of the questions of the test because the student is only told his grade so far (r/q) without identifying which of the q questions was properly marked and which not, challenging the student to re-submit after thoughtful modifications of the answers; and where the grading mechanism will respond to the second submission with a grade of (r₂/q)−p₂, where r₂ is the number of correct answers marked in the second submission, and p₂ is a penalty designed to distinguish between achieving the same value of correct answers in the first round, and in the second round; and where the student is told his new grade, substituting for his former grade, while, again, not indicating to the student which answers were correctly marked; and the method further allows the student to re-submit his answers to the test some t times, in succession, and for every submission round, i (1<i≦t) the calculated grade will be: (rᵢ/q)−pᵢ, where rᵢ is the number of correct answers marked in the i-th submission, and pᵢ is a penalty designed to distinguish between achieving the same value of correct answers (rᵢ=rᵢ₋₁) in the previous round, and where the grade in the last submission is the final grade of the test, even, as may be common, the number of correct answers in the last submission is the same, or less, than the number of correct answers in previous rounds.

2. A method as in (1) where the formula for the penalty is pᵢ=p₀*(i−1) where i is the count of submission rounds of the test, and p₀ is the penalty increment that is added per round.

3. A method as in (1) where the formula for the penalty is pᵢ=p₀*(i−1) where i is the count of submission rounds of the test, and p₀ is the penalty increment that is added per round; but in the event that rᵢ=q, then the penalty will be pᵢ=p′₀(i−1), where p′₀<p₀ so that the student is well motivated to continue and submit the best modified results for the test, until at round i, rᵢ=q, and the grade will be considerably higher, than without this special award, for getting all the answers right, after however many submissions.

4. A method as in (1) where the grading is carried out through software, and the graded student submits his or her answer through the network to a grading module which communicates with the student according to the protocol defined in (1), so that the grading is instantaneous, and may be carried out around the clock.
